(19) United States
(12) Patent Application Publication
(10) Pub. No.: US 2015/0021227 A1
(43) Pub. Date: Jan. 22, 2015

(54) Packaging Tray for Food Products and/or Merchandise

(71) Applicant: Tri-State Container Corporation, Bensalem, PA (US)

(72) Inventors: Matthew Coon, Cherry Hill, NJ (US); Robert J. Fuerst, Conshohocken, PA (US); Brian Mellor, Philadelphia, PA (US)

(21) Appl. No.: 14/330,400

(22) Filed: Jul. 14, 2014

Related U.S. Application Data
(60) Provisional application No. 61/845,547, filed on Jul. 12, 2013.

(51) Int. Cl. B65D 5/30; B31B 1/50; B31B 1/26

(52) U.S. Cl. CPC B65D 5/304; B31B 1/26; B31B 1/50
USPC 206/557; 229/175; 493/137; 493/162

(57) ABSTRACT

A packaging tray configured for assembly without staples or other fasteners is provided.

### CROSS-REFERENCE TO RELATED APPLICATION

This application claims the priority and benefit of U.S. Provisional Patent Application Ser. No. 61/845,547 entitled “Packaging Tray for Food Products and/or Merchandise,” filed on Jul. 12, 2013, the entirety of which is incorporated herein by reference.

### FIELD OF INVENTION

The invention generally relates to improvements in the structure and configuration of a packaging tray for food products, merchandise, and the like. More specifically, the invention relates to a packaging tray for food products, merchandise, and the like, wherein the packaging tray can be assembled from a blank without using staples or other fasteners.

### BACKGROUND OF THE INVENTION

Manufacturers, merchants, and retailers use packaging trays to pack food products, merchandise, and the like and also to protect the packed contents during storage and transport to a storage location or store. Packaging trays can be used to transport merchandise to various locations including, but not limited to, grocery stores, convenient marts, gas stations, retail stores and outlets, and the like.

Merchandise can be packed in packaging trays to prevent the merchandise from being crushed, damaged, or destroyed while in storage, during transport/shipment, and through to placement of the merchandise on a shelf for sale. In a commercial embodiment, the merchandise can be consumables, such as, for example, bread products (e.g., loaves of bread, bread rolls, and the like), fruits, vegetables, packaged and/or processed/frozen foods, and the like. Furthermore, the merchandise may be any product that is not a consumable.

Many existing packaging trays present drawbacks. For example, existing packaging trays can be costly to manufacture, have commercially-unacceptable failure rates, and are capable of only one-time use (e.g., not reusable). These packaging trays must be assembled with staples or other penetrating fasteners and thus are difficult to assemble and then later disassemble and store, reuse, or discard.

Therefore, a need exists for an improved packaging tray for packing, storing, and transporting food products, merchandise, and the like in such a way that the packaging tray: (a) can be easily assembled and disassembled by hand or machine without the use of fastener devices, (b) can be quickly and conveniently assembled into a uniform packaging tray and deployed for use, (c) can contain a variety of consumer merchandise, including, but not limited to, food products (packaged and unpackaged), general consumer products, and the like, (d) can be stacked, (e) is structurally stable, (f) can be easily disassembled, stored, and reassembled for use, (g) is efficiently and inexpensively manufactured, and (h) can be customized with marketing and advertising graphics that are specific for a manufacturer, retailer, or merchant.

### BRIEF DESCRIPTION OF THE DRAWINGS

Additional aspects, features, and advantages of the invention, both as to its structure, assembly, and use, will be understood and become more readily apparent when the invention is considered in light of the following description of illustrative embodiments made in conjunction with the accompanying drawings, wherein:

FIG. 1 shows an embodiment of a cardboard blank for the packaging tray of the invention.

FIG. 2 shows the beginning point for assembling the cardboard blank of FIG. 1 into the packaging tray according to the invention.

FIG. 3 shows an assembly step for the packaging tray according to the invention.

FIG. 4 shows anther assembly step for the packaging tray according to the invention.

FIG. 5 shows a further assembly step for the packaging tray according to the invention.

FIG. 6 shows an even further assembly step for the packaging tray according to the invention.

FIG. 7 shows yet another assembly step for the packaging tray according to the invention.

FIG. 8 shows the packaging tray assembled according to the invention.

FIG. 9 shows another embodiment of a cardboard blank for a packaging tray of the invention.

FIG. 10 shows yet another embodiment of a cardboard blank for a packaging tray of the invention.

### DETAILED DESCRIPTION OF EMBODIMENTS OF THE INVENTION

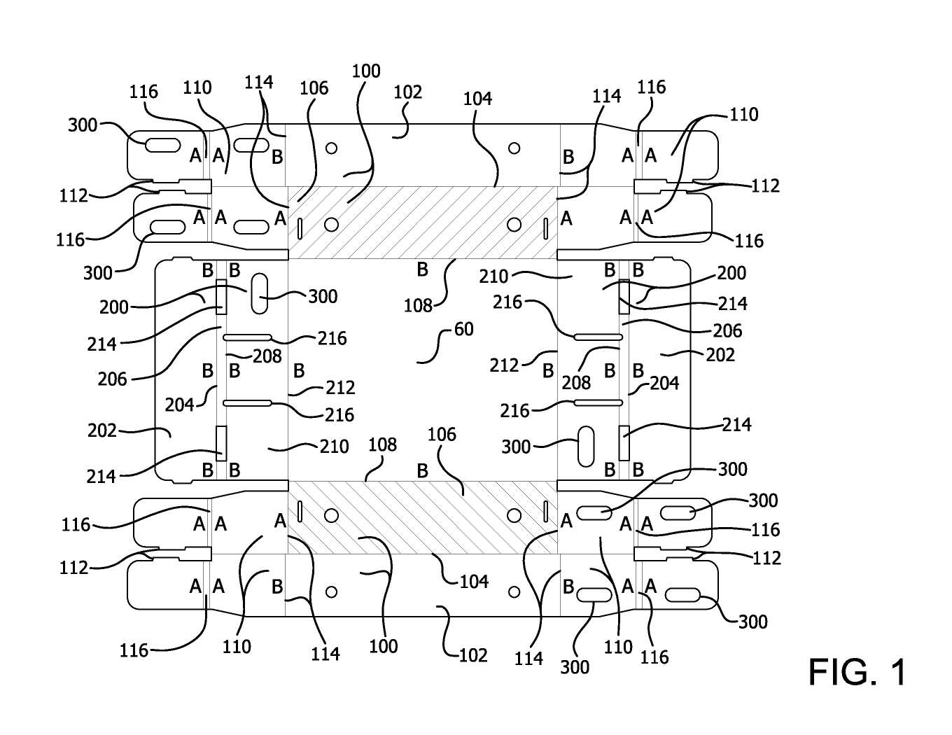

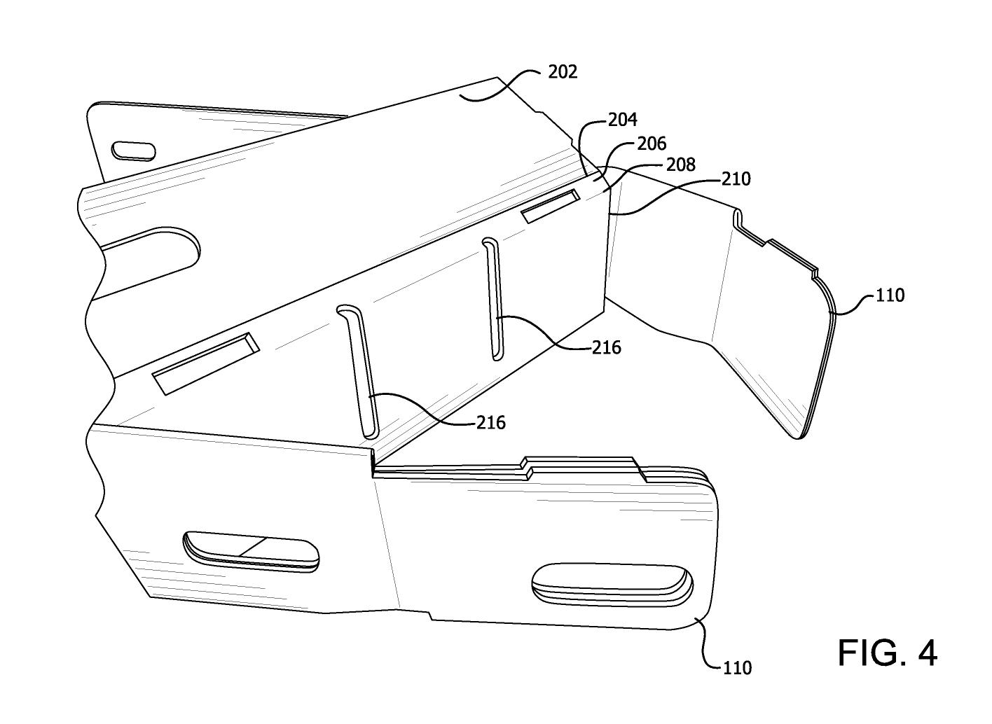

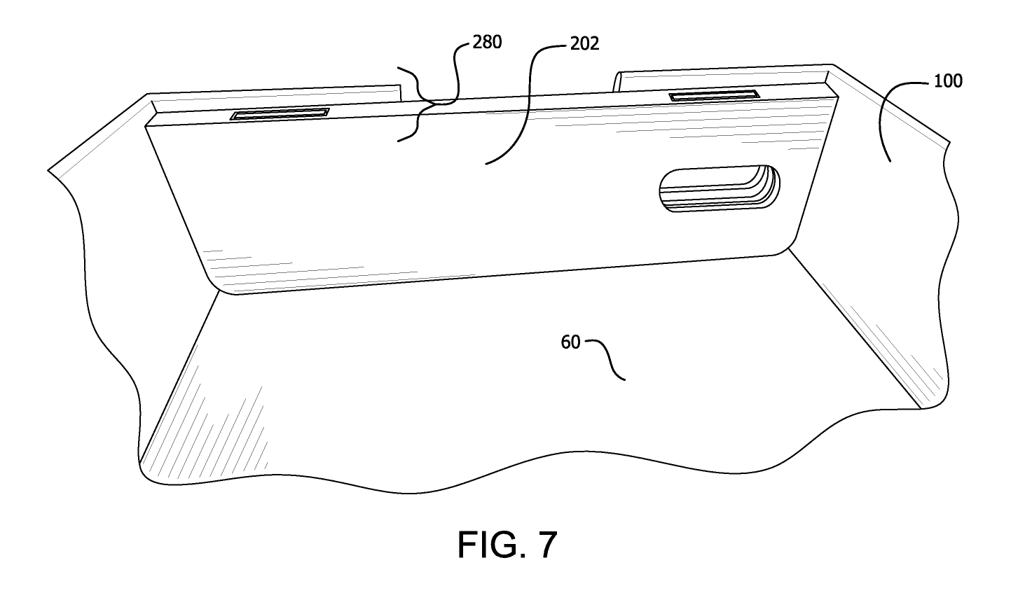

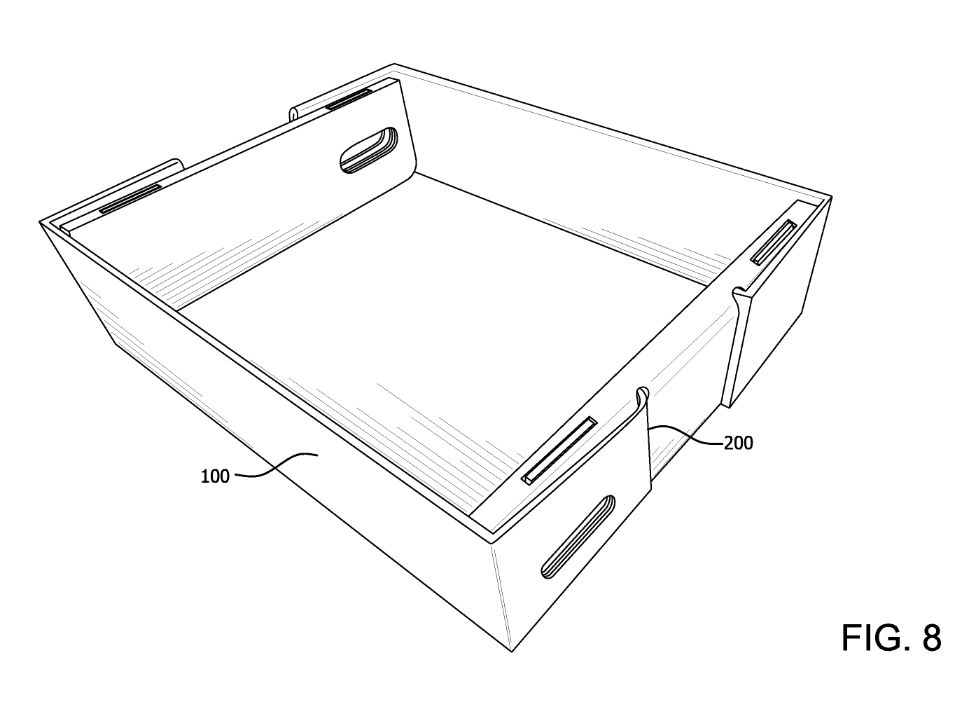

Illustrative and alternative embodiments of a packaging tray 20, 20′ is discussed in detail, as follows, with reference to FIGS. 1-10 of this application. The invention provides an improved packaging tray 20, 20′ for merchandise and methods of assembly and use therefor.

A purpose of the invention is to provide a packaging tray 20, 20′ that can be shipped and/or stored unassembled as a substantially flat piece of cardboard. The purpose of the invention also includes providing a packaging tray 20, 20′ that can be easily assembled and disassembled by hand or machine without the use of fastener devices, such as staples, to assemble the packaging tray 20, 20′. Another purpose of the invention is to provide a packaging tray 20, 20′ that can be quickly, conveniently, and uniformly assembled and deployed for commercial use and reuse. In addition, the packaging tray 20, 20′ can be easily disassembled, stored, and/or reassembled for use. Yet another purpose of the invention is to provide a packaging tray 20, 20′ that can contain a variety of consumer merchandise including, but not limited to, packaged food products, general consumer products, and the like. An even further purpose of the invention is to provide a packaging tray 20, 20′ that can be stacked and remain structurally stable. Yet an even further purpose of the invention is to provide a packaging tray 20, 20′ that is efficiently and inexpensively manufactured and that can be customized with marketing and advertising graphics that are specific for a manufacturer, retailer, or merchant.

Illustrative embodiments of the invention—a packaging tray 20, 20′ comprising a box-like configuration without a top—are described. Although similar aspects of the embodiments of the invention are featured throughout this disclosure and are readily apparent, these similarities will be repeated, as needed, in context with the variations of each embodiment.

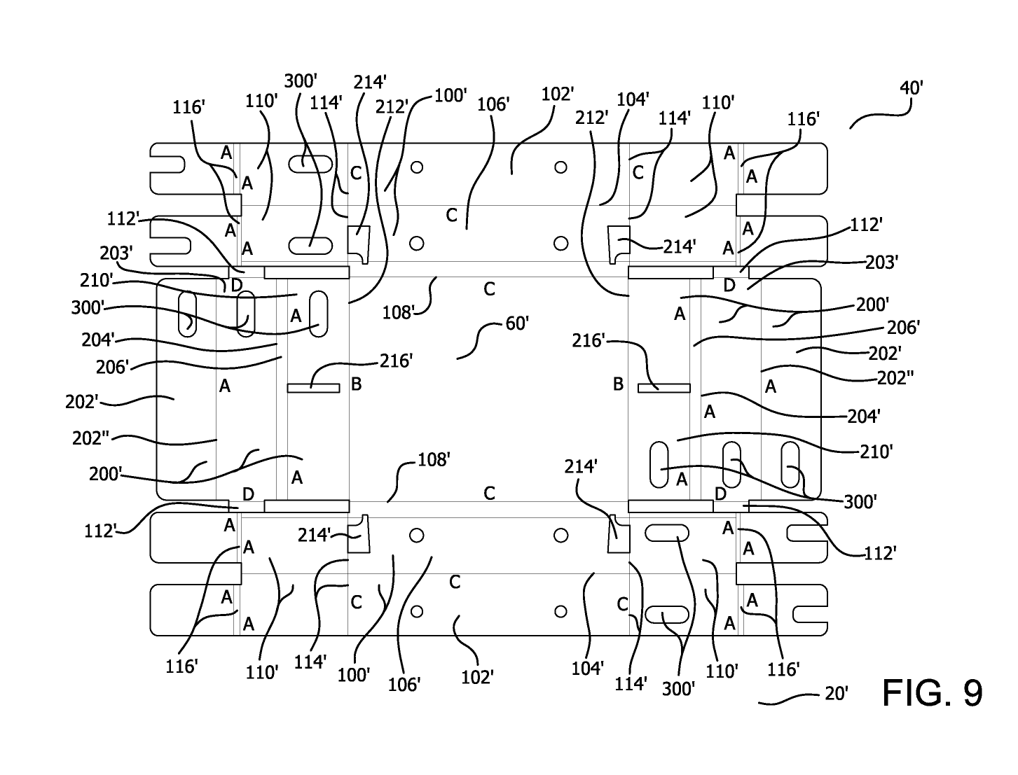

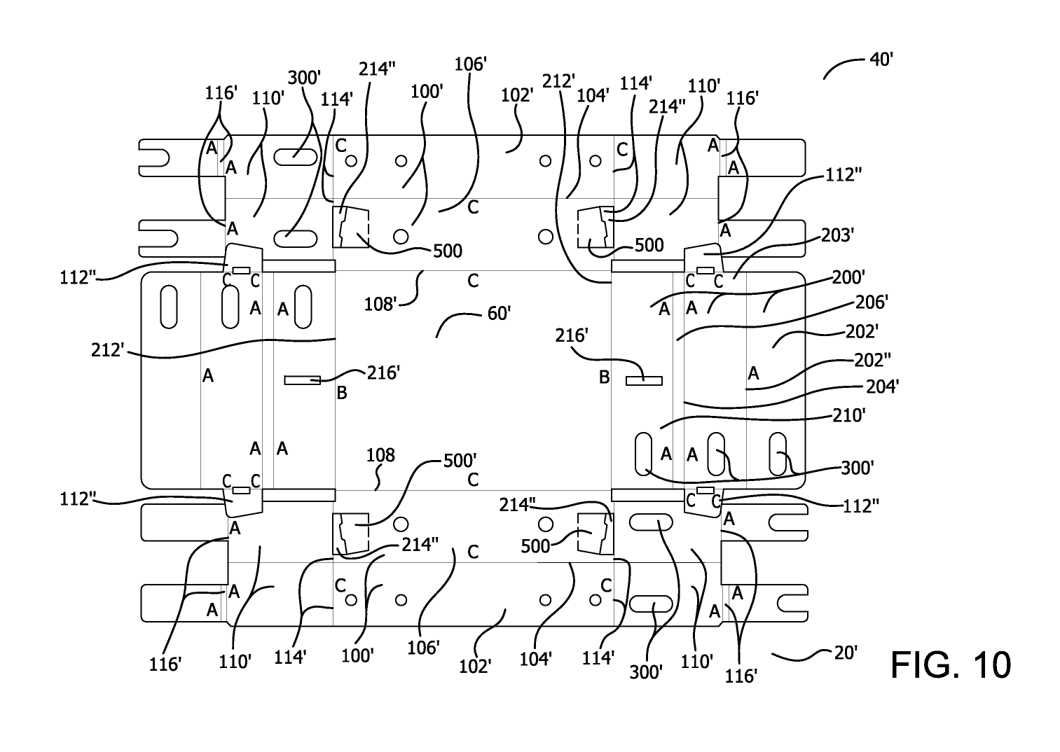

Blank 40 for a packaging tray 20 is shown in FIG. 1, while alternative blanks 40′ for packaging tray 20′ are shown in FIGS. 9 and 10. Blanks 40, 40′ each comprise a bottom panel 60, 60′, side panels 100, 100′, end flaps 110, 110′, and end panels 200, 200′, respectively, that can be formed into the packaging tray 20, 20′, respectively, of the invention. Blanks 40, 40′ may be die cut from cardboard or other suitable material and scored. In alternative embodiments, blanks 40, 40′ may be prepared by any process useful for cutting and scoring cardboard or other suitable material.

Referring to FIG. 1 wherein the blank 40 is shown, each side panel 100 comprises a first subpanel 102 contiguous along a subpanel fold line 104 with a second subpanel 106. The second subpanel 106 is contiguous along a bottom fold line 108 with the bottom panel 60. The subpanel fold line 104 is provided so that the first subpanel 102 can be folded towards and contact with the second subpanel 106. The length of the side panel 100 is defined between each of the first set of score lines 114. This length is slightly longer than the length of the bottom panel 60.

Alternatively, and for blanks 40′ shown in FIGS. 9 and 10, each side panel 100′ comprises a first subpanel 102′ contiguous along a subpanel fold line 104′ with a second subpanel 106′. The second subpanel 106′ is contiguous along a bottom fold line 108′ with the bottom panel 60′. The subpanel fold line 104′ is provided so that the first subpanel 102′ can be folded towards, and be in contact with, the second subpanel 106′. The length of the side panel 100′ is defined between each of the first set of score lines 114′. This length is slightly longer than the length of the bottom panel 60′.

Referring again to FIG. 1, the end flaps 110 are provided and comprise generally rectangular-shaped pieces of cardboard or other material. The end flaps 110 are defined in part by the edges of the rectangular-shaped pieces of cardboard or other material and the first set of score lines 114 of the first and second subpanels 102, 106 of the side panel 100. Lock tabs 112 are provided along the top edge of the end flap 110. The lock tabs 112 are configured to fit within the tab slots 214 provided in the edge 206 of the end panels 200.

Referring now to FIGS. 9 and 10, wherein alternative blanks 40′ are shown, the end flaps 110′ are provided and comprise generally rectangular-shaped pieces of cardboard or other material. The end flaps 110′ are defined in part by the edges of the rectangular-shaped pieces of cardboard or other material and the first set of score lines 114′ of the first and second subpanels 102′, 106′ of the side panel 100′.

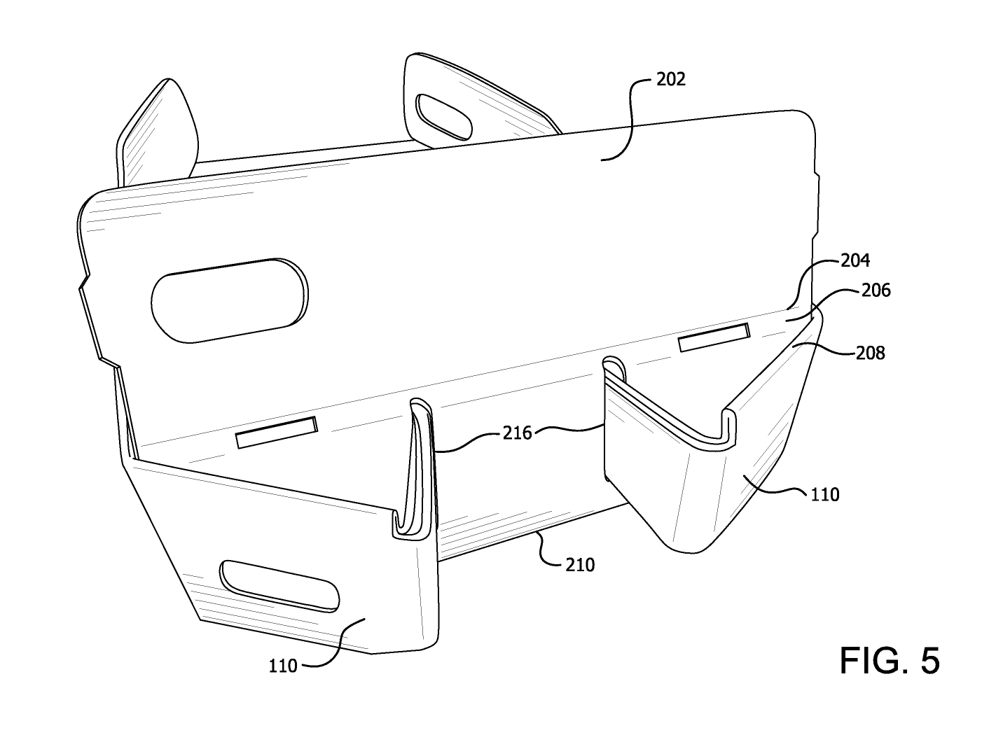

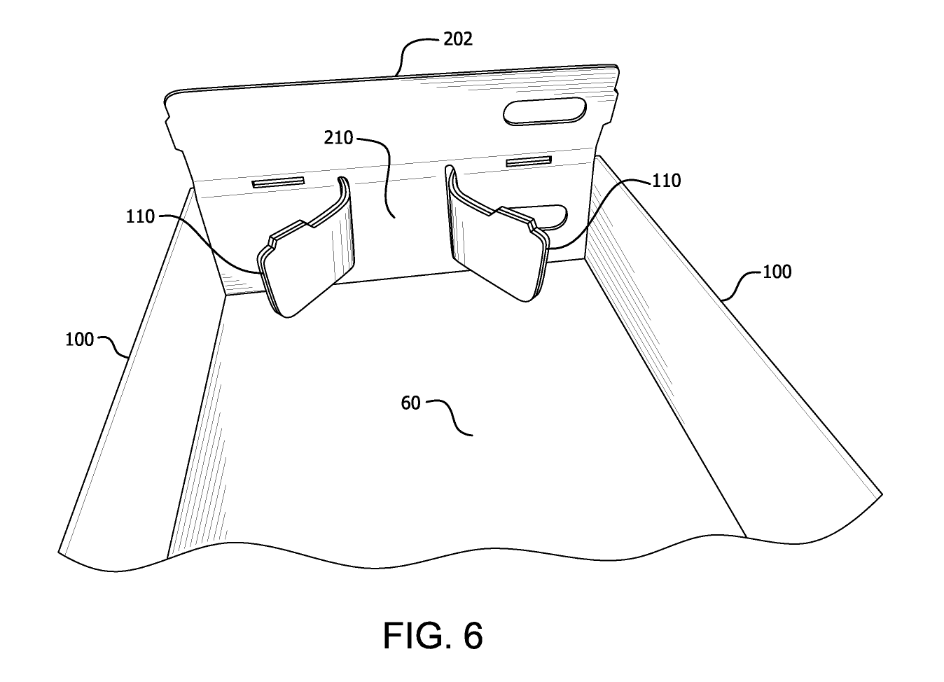

Referring yet again to FIG. 1, each end flap 110 comprises a second set of score lines 116. The first set and second set of score lines 114, 116 permit the end flaps 110 to be folded inward to fit within the slots 216 of the end panel 200 as shown in FIGS. 5 and 6. More specifically, the first set of score lines 114 (e.g., a perforated score A between end flap 110 and the second subpanel 106 AND a reverse matrix score B between the end flap 110 and the first subpanel 102) permit an inner portion of the end flap 110 to be formed by folding the end flap 110 at about a 90 degree angle from the side panel 100. In addition, the second set of score lines 116 (e.g., a reverse matrix score B between the end flap 110 and the first subpanel 102) permit an outer portion of the end flap 110 to be folded back at about 180 degrees from the inner portion of the end flap 110 as shown in FIG. 6. The dimensions of the end flaps 110 are configured to fit within and slide through the slot 216 provided in the end panel 200.

In alternative embodiments of blanks 40′ shown in FIGS. 9 and 10, each end flap 110′ comprises a second set of score lines 116′. The first set and second set of score lines 114′, 116′ permit the end flaps 110′ to be folded inward to fit within the slot 216′ of the end panel 200′. More specifically, the first set of score lines 114′ (e.g., score C between end flap 110′ and the second subpanel 106′ AND score C between the end flap 110′ and the first subpanel 102′) permit an inner portion of the end flap 110′ to be formed by folding the end flap 110′ at about a 90 degree angle from the side panel 100′. In addition, the second set of score lines 116′ (e.g., score A between the end flap 110′ and the first subpanel 102′) permit an outer portion of the end flap 110′ to be folded back at about 180 degrees from the inner portion of the end flap 110′. The dimensions of the end flaps 110′ (from opposite panels 100′) are configured to fit within and slide through slot 216′ provided in the end panel 200′.

Referring yet again to FIG. 1, each end panel 200 comprises a first subpanel 202 contiguous along a first edge score line 204 (e.g., reverse matrix scores B) with the edge 206 and a second subpanel 210 contiguous along a second edge score line 208 (e.g., reverse matrix scores B) with the edge 206. The second subpanel 210 is contiguous along bottom fold line 212 (e.g., reverse matrix scores B) with the bottom panel 60. The score lines 204, 208 permit the first subpanel 202 to be folded towards the second subpanel 210 while having the edge 206 create a distance between the first subpanel 202 and the second subpanel 210 of the end panel 200. This distance is about twice the thickness of the cardboard or other material used for the blank 40.

Each end panel 200 shown in FIG. 1 comprises tab slots 214 provided along the edge 206. The tab slots 214 are configured to receive and secure the lock tabs 112 of the end flaps 110 of the side panels 100.

Alternatively, and referring again to FIGS. 9 and 10, each end panel 200′ comprises a first subpanel 202′ contiguous along a score line 202″ (e.g., score A) with a second subpanel 203′. Second subpanel 203′ is contiguous along a first edge score line 204′ with the edge 206′ and a third subpanel 210′ is contiguous along a second edge score line 208′ (e.g., score A) with the edge 206′. The third subpanel 210′ is contiguous along bottom fold line 212′ (e.g., score B) with the bottom panel 60′. Score line 202″ permits the first subpanel 202′ to be folded toward and rest against the second subpanel 203′. While in turn, the score lines 204′, 208′ permit the first and second subpanels 202′, 203′ to be folded towards the third subpanel 210′ while having the edge 206′ create a distance between the second subpanel 203′ and the third subpanel 210′ of the end panel 200′. This distance is about twice the thickness of the cardboard or other material used for the blank 40′.

Referring specifically to FIG. 9, each of second subpanels 203′ comprise tabs 112′ that extend away from the second subpanels 203′ in opposing directions. Corresponding slots 214′ of second subpanels 106′ are configured to receive and secure tabs 112′ in an assembled packaging tray 20′. Alternative tabs 112″ are shown in FIG. 10, also extending away from second subpanels 203′. Corresponding slots 214″ of second subpanels 106′ are configured to receive and secure tabs 112″ in an assembled packaging tray 20′.

In an embodiment, the perforated scoring A may comprise a ½″ perforation to ½″ non-perforation scheme and matrix scoring B. Alternatively, the scoring may comprise any one or combination of perforated scoring A, matrix scoring B, and any other type of scoring that permits folding of the panels and subpanels of the invention as disclosed in this application.

In embodiments, corresponding hand holds 300, 300′ may be provided through an end flap 110, 110′ and the end panel 200, 200′. In other embodiments, communications of any shape may be provided in the packaging tray 20, 20′.

Blanks 40, 40′ of the invention may be die cut or otherwise prepared from corrugated cardboard comprising any paper gauge, flute, and grade. The cardboard may be any one or combination of single-, double-, or triple-walled cardboard so long as the selected gauge, flute, and grade provides a durable material that can be scored and folded while retaining the structure and function of the invention disclosed in this application. In alternative embodiments, blanks 40, 40′ may comprise other materials such as, for example, cardboard layered or coated with other materials such as, for example, plastic, wax, or other coating material; plastic; or other suitable material including layered material that provides a durable packaging tray.

The bottom panel 60, 60′ of the packaging tray 20, 20′ may be square or rectangular with any dimension that is useful for the purposes of the invention. The side panels 100, 100′ and end panels 200, 200′ may also be square, rectangular, or other dimension that is useful for the purposes of the invention.

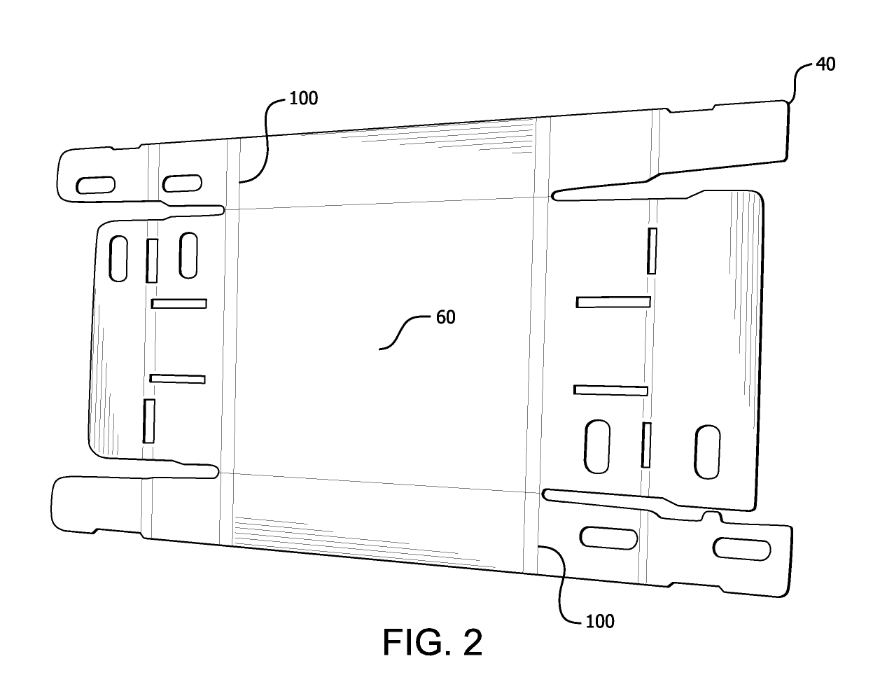

The packaging tray 20 can be assembled according to the methods of the invention as shown more specifically in FIGS. 2-8.

The methods of assembling the packaging tray 20 of the invention may comprise pre-breaking all score lines (e.g., perforated score lines A and reverse matrix score lines B) of the blank that is depicted in FIG. 1. In alternative embodiments, the step of pre-breaking score lines can take place during the assembly steps rather than as a stand-alone step.

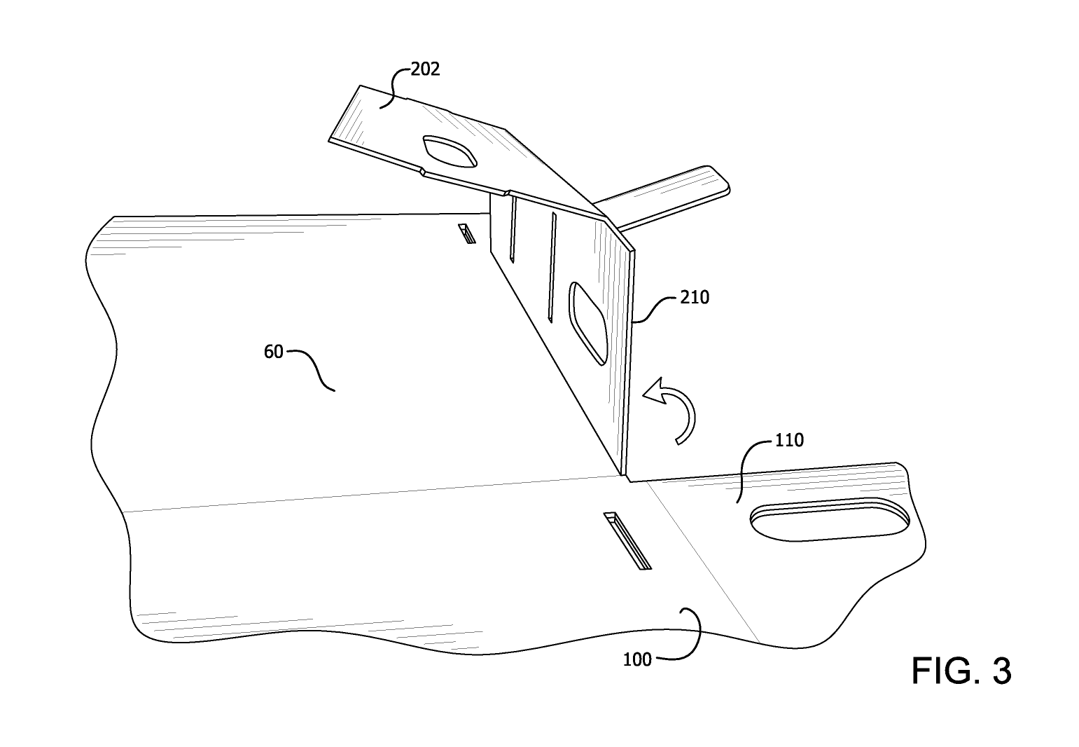

Referring now to FIGS. 3-7, the assembly method comprises forming an end panel 200 of the packaging tray 20. This takes place by folding the second subpanel 210 of the end panel 200 upwards along the bottom fold line 212 to about 90 degrees relative to the bottom panel 60. Then, the method comprises folding the first subpanel 202 downward along the first edge score line 204 at about 90 degrees to the edge 206. Next, the method comprises folding the second subpanel 210 downward along the second edge score line 208 at about 90 degrees to the edge 206. Of course, the specific sequence of the aforementioned folding steps is not critical for forming the end panel 200 so long as all of the folding steps take place. This step of forming the end panel 200 must be repeated for the other opposing end panel 200.

Referring again to FIGS. 3-7, the assembly method comprises forming the side panels 100 of the packaging tray 20. This takes place by folding the first subpanel 102 upward along the subpanel fold line 104 so that a surface of the first subpanel 102 contacts a surface of the second subpanel 106. No glue is used to secure the subpanels together. In an optional embodiment, an adhesive such as, for example, glue may be placed along the contacting surfaces of the first subpanel 102 and the second subpanel 106. The adhesive secures the two subpanels 102, 106 together. Then, the method comprises folding the side panel 100 upwards along the bottom fold line 108 so that the side panel 100 is positioned at about 90 degrees relative to the surface of the bottom panel 60. Of course, the specific sequence of the aforementioned folding steps is not critical for forming a side panel 100 so long as all of the folding steps take place. This step is repeated for the other side panel 100.

Referring to FIGS. 2-7, the assembly method comprises forming the end flaps 110 of the packaging tray 20. This takes place by folding each end flap 110 inward toward the end panel 200 along a first set of score lines 114. The end flap 110 can be folded at about 90 degrees relative to the surface of the side panel 100. Each end flap 110 is then folded along a second set of score lines 116 at about 90 degrees relative to the surface of the end flap 110. This is repeated in order to form a total of four end flaps 110.

Referring specifically to FIGS. 5 and 6, the assembly method comprises sliding the outer portion of an end flap 110 through the slot 216 that is closest to the end flap 110 in the end panel 200. The outer portion of each end flap 110 is slid completely through the slot 216 so that the first set of score lines 114 are positioned adjacent to an internal edge of the slot 216 and the end flap 110 contacts a surface of the end panel 200. The outer portion of the end flap 110 projects through the slot 216 at about 90 degrees to the inner surface of the end panel 200. This outer portion of the end flap 110 is then folded along the second set of score lines 116 and toward the side panel 100 from which the end flap 110 extends.

Referring generally to FIGS. 1-8, the assembly method comprises folding the first subpanel 202 of the end panel 200 inward and toward the bottom panel 60 to form the end panel 200. While the first subpanel 202 is being folded into place to form the end panel 200 of the packaging tray 20, the outer portion of each end flap 110 in contact with the inner surface of the end panel 200 is held in place so that the lock tabs 112 of the end flaps 110 engage the tab slots 214 provided in the edge 206 of the end panel 200. Additional lock tabs may be provided along the side edge of the first subpanel 202 of the end panel 200. If present, the lock tabs would engage corresponding slots provided on the first subpanel 202 of the side panels 100 and lock the first subpanel 202 of the end panel 200 in place to complete the formation of the end panel 200.

The aforementioned steps are repeated to secure the end flaps 110 in place while forming the other end panel 200 and consequently the packaging tray 20.

Packaging tray 20′ can be assembled from the blanks 40′ shown in FIGS. 9 and 10 according to the methods of the invention.

The methods of assembling the packaging tray 20′ of the invention may comprise pre-breaking all score lines (e.g., score lines A, B, and C) of the blanks 40′ that are depicted in FIG. 9 or 10. In alternative embodiments, the step of pre-breaking score lines can take place while assembly is taking place rather than as a stand-alone step.

The assembly method comprises forming an end panel 200′ of the packaging tray 20. This takes place by folding the first subpanel 202′ along a score line 202″ to rest against the second subpanel 203′. Then, the method comprises folding the first and second subpanels 202′, 203′ along the first edge score line 204′ to form an approximate 90 degree angle with the edge 206′, and then folding the third subpanel 210′ along second edge score line 208′ to form an approximate 90 degree angle with the edge 206′. Next, the method comprises folding the third subpanel 210′ along the bottom fold line 212′ (e.g., score B) to form an approximate 90 degree angle with the bottom panel 60′. Of course, the specific sequence of the aforementioned folding steps is not critical for forming the end panel 200 so long as all of the folding steps take place. This step of forming the end panel 200 must be repeated for the other opposing end panel 200.

The assembly method comprises forming the side panels 100′ of the packaging tray 20′. This takes place by folding the first subpanel 102′ along the subpanel fold line 104′ so that a surface of the first subpanel 102′ contacts a surface of the second subpanel 106′. no glue is used to secure the subpanels together. In an optional embodiment, an adhesive such as, for example, glue may be placed along the contacting surfaces of the first subpanel 102′ and the second subpanel 106′. The adhesive secures the two subpanels 102′, 106′ together. Then, the method comprises folding the side panel 100′ upwards along the bottom fold line 108′ so that the side panel 100′ is positioned at about 90 degrees relative to the surface of the bottom panel 60. Of course, the specific sequence of the aforementioned folding steps is not critical for forming a side panel 100′ so long as all of the folding steps take place. This step is repeated for the other side panel 100′.

Next, the assembly method comprises forming the end flaps 110′ of the packaging tray 20′. This takes place by folding each end flap 110′ inward toward the end panel 200′ along a first set of score lines 114′. The end flap 110′ can be folded at about 90 degrees relative to the surface of the side panel 100′. Each end flap 110′ is then folded along a second set of score lines 116′ at about 90 degrees relative to the surface of the end flap 110′. This is repeated in order to form a total of four end flaps 110′.

The assembly method further comprises sliding the outer portion of an end flap 110′ through the slot 216′ that is closest to the end flap 110′ in the end panel 200′. The outer portion of each end flap 110′ is slid completely through the slot 216′ so that the first set of score lines 114′ are positioned adjacent to an internal edge of the slot 216′ and the end flap 110′ contacts a surface of the end panel 200′. The outer portion of the end flap 110′ projects through the slot 216′ at about 90 degrees to the inner surface of the end panel 200′. This outer portion of the end flap 110′ is then folded along the second set of score lines 116′ and toward the side panel 100′ from which the end flap 110′ extends.

The assembly method comprises folding the first and second subpanels 202′, 210′ of the end panel 200′ inward and toward the bottom panel 60′ to form the end panel 200′. While the first and second subpanels 202′, 203′ are being folded into place to form the end panel 200′ of the packaging tray 20′, the outer portion of each end flap 110′ in contact with the inner surface of the end panel 200′ is held in place so that the lock tabs 112′ or 112″ of the end panels 200′, as shown in FIGS. 9 and 10, engage the slots 214′ or 214″, respectively, provided in the side panel 100′ and lock the second subpanel 203′ of the end panel 200′ in place to complete the formation of the end panel 200′. In an alternative embodiment, lock tabs 500 may be provided in subpanel 106′. Lock tabs 500 may be attached along one or more edges with subpanel 106′. Lock tabs 500 may be temporarily folded open so that tabs 112″ may be positioned in corresponding slots 214″ and, then, the lock tabs 500 may be repositioned along the same surface of subpanel 106′ to secure the slots 214″ in place. This process would be reversed in order to break down the packing tray 20′ having tabs 112″ and lock tabs 500.

The aforementioned steps are repeated to secure the end flaps 110′ in place while forming the other end panel 200′ and, consequently, the packaging tray 20′.

A benefit of the aforementioned methods is that the packaging tray 20, 20′ can be shipped and stored unassembled in a substantially flat form. The packaging tray 20, 20′ can be assembled without the use of staples or other types of fasteners. Another benefit of the invention is that it can be quickly and easily disassembled and stored in a compact form for later assembly and use or discarded.

A further benefit of the invention is that its features promote a stable packaging tray 20, 20′. This permits stacking of the packaging tray 20, 20′ which remains stable when stacked.

Yet another benefit of the invention is that it provides a packaging tray 20, 20′ that can contain a variety of consumer merchandise including, but not limited to, packaged food products, general consumer products, and the like.

Yet an even further benefit of the invention is that it provides a packaging tray 20, 20′ that is efficiently and inexpensively manufactured.

Another aspect of the invention is that it can be customized with marketing and advertising graphics that are specific for a manufacturer, retailer, or merchant. Customization may occur by printing graphics, logos, trademarks, and other information on blank 40, 40′ before or after die-cutting the blank 40, 40′.

While the invention has been described above in conjunction with specific embodiments, it is evident that many alternatives, modifications, permutations, and variations will become apparent to those skilled in the art in light of the foregoing description. Accordingly, it is intended that the present invention embraces all such alternatives, modifications, and variations as fall within the scope of the claims below.

What is claimed is:

1. A staple-less packaging tray comprising:
a box, said box having a bottom panel, two side panels, and two end panels;
two end flaps are provided contiguous with each side panel;
two locking tabs are provided along a top edge of said end flaps; and
a plurality of slots provided along an upper edge of each of said end panels,
wherein said end flaps are sandwiched between subpanels of each of said end panels.

2. A staple-less packaging tray comprising:
a box having a bottom panel, two side panels, and two end panels;
two end flaps contiguous with each of said side panels;
two locking tabs provided along a side edge of said end flaps; and
a plurality of slots provided in an internal surface of each of said side panels,
wherein said end flaps are sandwiched between subpanels of said end panel.

3. A method for assembling a staple-less package tray from a blank comprising:
positioning two side panels of said blank at about 90 degrees from a bottom panel of said blank by bending scored fold lines between said side panels and said bottom panel;
positioning a first end panel at about 90 degrees from a bottom panel of said blank by bending along a score line between said first end panel and said bottom panel;
inserting an outer portion of said first set of end flaps through corresponding slot in said first end panel and folding said outer portion of said first set of end flaps in toward an inner surface of said first end panel;
securing a first subpanel of said end panel to said packaging tray by sandwiching said first set of end flaps between said first subpanel and second and third subpanels of said end panel;
inserting an outer portion of said second set of end flaps through corresponding slots in said second end panel and folding said outer portion of said second set of end flaps in toward an inner surface of said second end panel; and
securing a first subpanel of said end panel to said packaging tray by sandwiching said first set of end flaps between said first subpanel and a second subpanel of said end panel and securing lock tabs of said first set of end flaps in slots of said end panel.

4. A method for assembling a staple-less package tray from a blank comprising:
positioning two side panels of said blank at about 90 degrees from said bottom panel by bending scored fold lines between said side panels and said bottom panel;
positioning a first end panel at about 90 degrees from a bottom panel of said blank by bending along a score line between said first end panel and said bottom panel;
inserting an outer portion of said first set of end flaps through corresponding slots in said first end panel and folding said outer portion of said first set of end flaps in toward an inner surface of said first end panel;
securing a first subpanel of said end panel to said packaging tray by sandwiching said first set of end flaps between said first subpanel and a second subpanel of said end panel;
inserting an outer portion of said second set of end flaps through corresponding slots in said second end panel and folding said outer portion of said second set of end flaps in toward an inner surface of said second end panel; and
securing a first subpanel of said end panel to said packaging tray by sandwiching said first set of end flaps between said first subpanel and a second subpanel of said end panel and securing lock tabs of said first set of end flaps in slots of said end panel.
